(19) United States
(12) Patent Application Publication
(10) Pub. No.: US 2011/0010989 A1
(43) Pub. Date: Jan. 20, 2011

(54) PLANT POT FILTER WITH MOISTURE PERMEABLE CHARACTERISTICS

(75) Inventor: Peter HINSPERGER, Mississauga (CA)

Correspondence Address: CARTER, DELUCA, FARRELL & SCHMIDT, LLP, 445 BROAD HOLLOW ROAD, SUITE 420, MELVILLE, NY, 11747, US

(73) Assignee: HINSPERGERS POLY INDUSTRIES LTD., Mississauga (CA)

(21) Appl. No.: 12/544,512

(22) Filed: Aug. 20, 2009

(30) Foreign Application Priority Data
Jul. 16, 2009 (CA) 2672350

(51) Int. Cl. A01G 9/02

(52) U.S. Cl. 47/65.6

(57) ABSTRACT

The present invention is directed to the use of a composite product for a plant pot filter, the composite comprises an open mesh weave of thermoplastic material, the weave has warp and weft strips which form a substantially uniform layer with opposed surfaces. The mesh defines individual slits extending through said layer. There is provided a discontinuous layer on one of the opposed surfaces, and a discontinuous layer on the other of the opposed surfaces. The invention is further directed to a plant pot having a moisture permeable filter, which comprises a composite filter, having the open mesh weave of thermoplastic material of the invention herein.

### FIELD OF THE INVENTION

The present invention relates to a plant pot filter, and to the use of a material for providing a filter for a plant pot.

### BACKGROUND ART

Planters or plant pots are in common use in residential and commercial establishments for decoration or grow purposes. Today, commercial plant growers, or nurseries, plant or transplant a large number of seeds, seedlings or small plants in a large variety of planters. Such planters include pots of all types, or even pre-formed foam or plastic containers which may hold from one to several plants.

Common practice today involves utilizing such containers for the purpose of providing a soil or other growing medium within the container; many containers are provided with one or more layers of water permeable material such as sand, gravel, stones or the like above which the growing medium, normally earth, is positioned.

It is generally common to provide one or more apertures in the bottom of the container to permit moisture, generally in the form of water, to escape from the container so as to avoid damaging the plants in the container. One of the problems associated with containers provided with a growing medium such as earth, is the fact that over a period of time, the growing medium will filter through the sand and/or gravel layers and eventually will cause the blockage of the apertures. This generally requires repacking the components of the container in order to permit water to escape from the bottom of the container.

### SUMMARY OF THE INVENTION

In accordance with one aspect of this invention there is provided an improved planter container which overcomes the moisture dispersibility of conventional containers, in another aspect of the present invention, there is provided a new use for a composite material which functions as an improved filter for containers or plant pots having plants or the like planted therein.

In greater detail, in accordance with one aspect of this invention, there is provided a plant pot which has a moisture permeable filter therein, the filter comprising a composite filter. This composite filter comprises an open mesh weave of thermoplastic material, having warp and weft strips which form a substantially thin uniform layer having opposed major surfaces, the layer having on one surface thereof a discontinuous or intermittent coating, such as a lace coating, and on the other surface a discontinuous or intermittent coating such as a lace coating. The mesh defines individual slits which extend through the layer. There is also provided a discontinuous layer on the other of said opposed surfaces.

In another aspect of the present invention, there is provided the use of a composite for a plant pot filter, said composite comprising an open mesh weave of thermoplastic material, said weave having warp and weft strips forming a substantially thin uniform layer having opposed surfaces, said mesh defining individual slits extending through said layer, and discontinuous layer on one of said opposed surfaces, and a discontinuous layer on the other of said opposed surfaces.

In a preferred embodiment of the present invention, the composite material is a continuous sheet of a one-piece “open” weave thermoplastic material which may be provided with suitable additives conventional in the industry as represented by ultraviolet stabilizers, extenders, anti-oxidants and the like. Properties of the composite of the present invention include the fact that it is moisture permeable as would be encountered when a planter or container is exposed to rain or under conditions of watering the container or plant pot e.g. with a hose while at the same time retaining moisture beneath the protective cover without permitting the same to be evaporated. In a like manner, the composite product permits the passage of atmospheric air under normal atmospheric conditions so that the composite “breathes”.

It is desirable that the composite layer comprises an open-mesh weave of thermoplastic material, the open-mesh weave comprising one or more substantially thin uniform layers of intersecting strands of thermoplastic material forming a substantially closed formation when in a lay-flat condition with the composite having opposed major surfaces, the open-mesh weave of thermoplastic material having a plurality of slits formed by intersecting strands of the open-mesh weave thereby permitting the passage of moisture therethrough.

The plastic material forming the strips of said composite can be any suitable material such as a polyolefin, where the preferred polyolefin is a polyethylene or polypropylene and the lace coating is a polyolefin such as a polyethylene compatible with the polyethylene strip.

The thickness of the core material used in the composite is not critical per se, as long as the composite product remains flexible to the extent that water is generally able to permeate therethrough; the thickness can be e.g. from 1 to several mils or more if desired. The lace coating may likewise be relatively thin so that an overall lightweight material may be employed. For given types of applications, it may be desirable to provide a border surrounding the mesh sheet material to provide an integral composite product; also, if desired the lace coating material may be extruded or otherwise bonded to the woven mesh material. The thickness of each coating may vary considerably depending on the type of material. Typically, preferred materials are thermoplastic in nature and by way of example such lace coatings may be a polyolefin such as polyethylene, polypropylene, co-polymers, etc., or other suitable materials known in the art.

One surface of the composite of the present invention is provided with a discontinuous or intermittent coating, such as a lace coating which may be of an irregular pattern. Thus, for example, suitable coatings may be formed from polymeric materials; these coatings may be or are desirably of an irregular pattern as applied to the woven intermediate layer. Desirably, this coating may cover between about 5% to about 60% of the woven layer on each surface or face thereof, and most desirably from about 10% to about 40% on each surface or face thereof. The coating may be applied by suitable conventional techniques such as calendering, spraying, co-extrusion, etc.

The other side of the composite product also has a lace coating which is also of an irregular pattern and extends linearly across the opposing surface in a like manner to the opposing side. As with the coating of the first surface described above, the coating for the opposite surface may also be formed from polymeric materials; these coatings of this layer may also be or are desirably of an irregular pattern as applied to the woven intermediate layer. Desirably this coating may only cover between about 5% to about 60% of the woven layer on each surface or face thereof, and most desirably about 10% to about 40% on each surface or face thereof. The coating may be applied by suitable conventional techniques such as calendering, spraying, co-extrusion, etc.

Given that a lace coating is applied to each major face of the scrim or woven core, depending on the degree of overlap of the lace coatings on one surface with the other, the total coverage by both lace coatings may vary considerably. For example, by having lace coatings applied to identical opposed layers on the woven core, the total coverage of the lace coatings for both major surfaces will be equal to the individual amount applied to each face. On the other hand, by varying the extent and location of the lace coating on one surface or face relative to another surface or face, the total coverage of the combined lace coating can increase considerably. Thus, the total coverage of the lace coatings can be as low as 5% of the total surface of the composite of the present invention or significantly higher (e.g. 80% or more) when the lace coatings do not overlap each other to any significant extent.

If desired, one or more reinforcing layers can also be included in the composite product where very thin composites are used. Such a reinforcing layer can be used to strengthen the composite product as desired, particularly for large containers or plant pots. Such reinforcing layers can be in the form of reinforcing scrims incorporated into the composite on one or both sides, desirably below the lace on the face. Reinforcing scrim layers are known in various arts; they may be incorporated into the composite on an in-line basis when the composite product is manufactured, or by extrusion, coating or like techniques. Any reinforcing layer should not reduce the total slit availability of the material to close off slit apertures between adjacent strands; it may contribute to a reduced slit availability where desired to thereby provide different characteristics for the woven material.

The composite products of the present invention are suitable for use in containers or pots to separate the soil or other growing medium from draining from the pots or containers. As a filter, the composite will retain the growing medium as a separate integral entity within the pot or container, while at the same time permitting water to drain from the pot or container through holes at the bottom of the pot or container which are located below the composite layer. The structure of the composite product is such that the growing medium, whether it be earth or other product, will not clog the slits or apertures in the composite, which would otherwise reduce the ability to drain the container or plant pot. Being made of a material such as a thermoplastic, the composite product will not decompose from water, soil or other chemicals used in the growing of plants.

The composite product can be produced in continuous lengths and then cut or trimmed to different sizes to fit different containers and pots. Normally, the composite product will have free edges, which will not unravel due to the outer layers of lace material on each surface of the core of the composite product. The composite product of the present invention can be formed by utilizing lengths of open mesh warp and weft weave material, and by subsequently applying polymeric material to each major surface or face to an extent whereby approximately e.g. 35% of each surface of the layer has the coating applied thereon. The coating, during application to each surface or face of the layer, can be applied in such a manner that overlapping occurs between the lace coating on the top layer and the lace coating on the bottom layer. In this manner, the ultimate composite had a total coating coverage of approximately e.g. 55% of the open mesh weave material when calculating the amount of coating as if it were applied to one side only.

As used herein, the term “plant pot” is intended to mean and refer to any suitable conventional container of the type adapted to receive earth or a growth medium, and which container is intended for use or functions as a planter for seeds, trees, flowers, etc. There are numerous types of containers well known to those skilled in the art made from materials ranging from ceramic to clay, plastic, metal or the like. All such containers are within the scope of the present invention.

### BRIEF DESCRIPTION OF THE DRAWINGS

Having thus generally described the present invention, reference will now be made to the accompanying drawings in which:

FIG. 1 is a top plan view of a moisture permeable filter of the present invention;

FIG. 2 is a side elevational view, partially in section, of a container or plant pot showing the use of the composite product within the container to act as a filter.

### DETAILED DESCRIPTION OF THE DRAWINGS

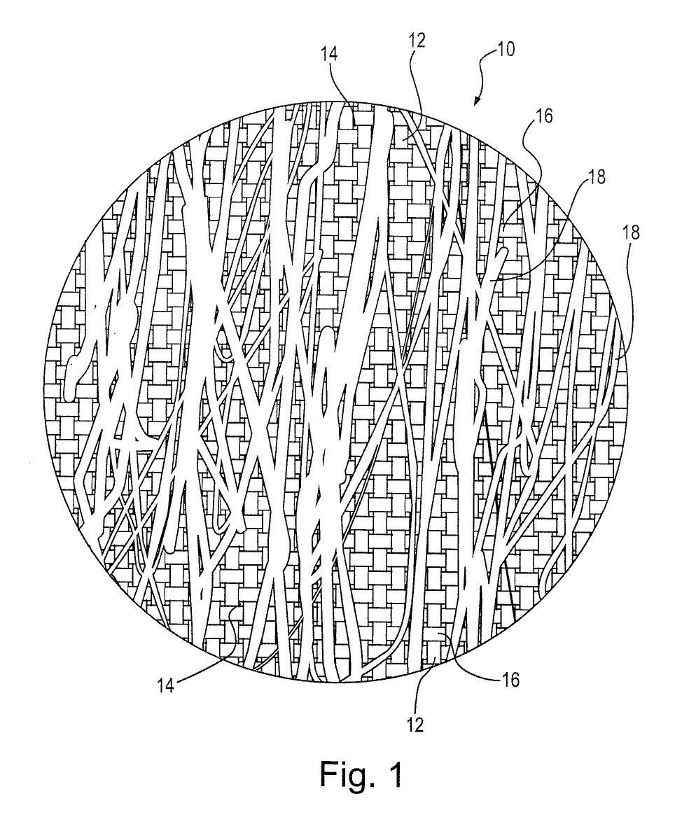

Referring initially to FIG. 1, there is illustrated in plan view, a composite product suitable for use as a moisture permeable filter in a plant pot or container, indicated generally by reference numeral 10. In this particular case, the composite is comprised of three layers—a first outer layer of a lace coating material in juxtaposition with a first outer face of the inner core; an inner core having opposed faces, and comprised of an open mesh weave of warp and weft strips 12 and 14, and an opposed outer layer similar to the outer layer described above, on the other face, and comprised of a lace covering or coating in juxtaposition with the open mesh weave.

The inner core with the warp and weft strips forms a substantially thin uniform layer with opposed major faces and may be made of, e.g., a suitable thermoplastic material such as polyethylene. The thickness of the warp and weft strips can vary considerably; for many applications a thickness of e.g. 1.5 mil is suitable.

Each of the outer faces of the open mesh weave is provided with a lace coating indicated generally by reference numeral 18; this lace coating is in the form of a discontinuous coating. The coating 18 only partially covers the outer surfaces of the inner core of open weave mesh as illustrated in FIG. 1.

As seen in FIG. 1, the intersecting warp and weft strips are generally of a loose weave leaving apertures or slits 14 at intersecting points. This provides a passage for the moisture or water to pass from one surface through to the other and provide drainage for the plant pot or container. At the same time, by virtue of the combination of the lace coating on each face of the inner core of open mesh weave material, the composite acts as a filter to prevent earth from passing through the composite.

For manufacturing of the composite product as illustrated in FIG. 1, polymeric material was applied separately to each major surface or face of the core of the non-woven material to an extent whereby approximately 35% of each surface of the layer had the coating applied thereon. The coating, during application to each surface or face of the layer, was applied in such a manner that overlapping occurred between the lace coating on the top layer and the lace coating on the bottom layer. In this manner, the ultimate composite product had a total coating coverage of approximately 55% of the open mesh weave material.

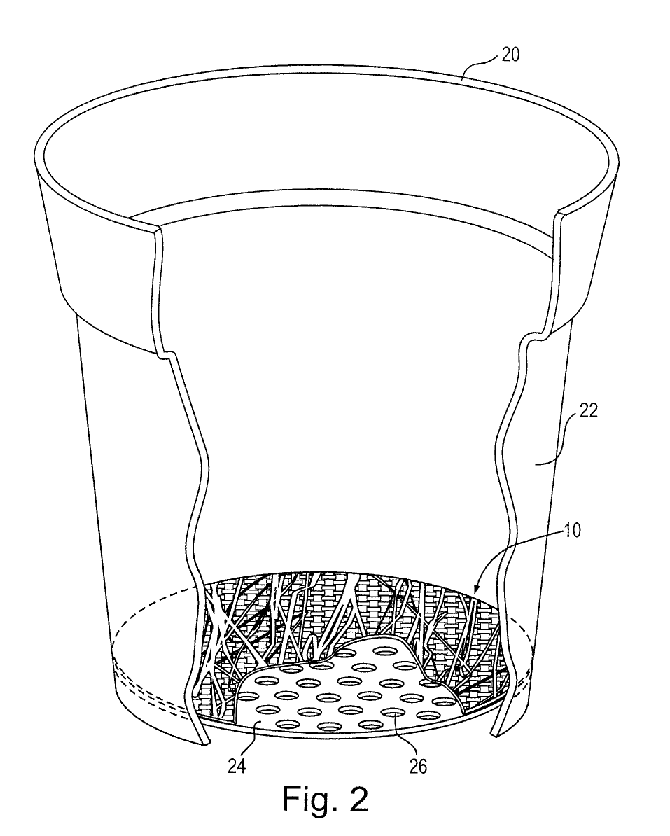

Referring now to FIG. 2, a conventional typical planter pot is illustrated and indicated by reference numeral 20. The illustrated planter pot 20 can be of a circular shape (as shown) although other shapes and configurations can be employed.

The planter pot 20 includes a continuous side wall 22 and an open top; the base of the planter pot indicated by reference numeral 24 closes the bottom of the pot and is provided typically with a plurality of apertures 26 to permit drainage of moisture from the pot.

From the sectional view shown in FIG. 2, it will be seen that the planter pot includes at the bottom of the pot and in juxtaposition with the base 24, a filter composite of the present invention indicated by reference numeral 10. This filter is preferably dimensioned to substantially cover the base of the planter pot and is normally merely placed against the base. However, in some cases, it may be desirable to secure the filter 10 to the base and this can be achieved by utilizing adhesives or otherwise by means such as screws or bolts.

As illustrated in FIG. 2, the filter 10 provides a barrier against the growth material from penetrating the apertures 26 while at the same time permitting water to flow from the planter pot through the openings 26.

Those skilled in the art to which the invention pertains will understand that the invention has been described by way of a detailed description of a preferred embodiment and departures from and variations to this arrangement may be made without departing from the spirit and scope of the invention.

I claim:

1. Use of a composite for a plant pot filter, said composite comprising an open mesh weave of thermoplastic material, said weave having warp and weft strips forming a substantially thin uniform layer having opposed surfaces, said mesh defining individual slits extending through said layer; a discontinuous layer on one of said opposed surfaces, and a discontinuous layer on the other of said opposed surfaces.

2. The use, according to claim 1, wherein each of said discontinuous layers comprises a coating having a thickness of at least 5 mil.

3. The use, according to claim 2, wherein each said coating covers between about 5% to about 60% of each surface of said composite layer.

4. The use, according to claim 3, wherein each said coating covers between about 10% to about 40% of each surface of said composite layer.

5. The use, according to claim 1, wherein the plastic material forming the strips of said composite is a polyolefin.

6. The use, according to claim 5, wherein said polyolefin is a polyethylene and said coating is a polyethylene compatible with said polyethylene strip.

7. The use, according to claim 1, wherein said slits of said open mesh weave are openings to permit moisture to permeate therethrough.

8. The use, according to claim 3, wherein said slits comprise openings permitting passage of moisture therethrough.

9. A plant pot having a moisture permeable filter therein, said filter comprising a composite filter, which comprises an open mesh weave of thermoplastic material, said weave having warp and weft strips forming a substantially thin uniform layer having opposed surfaces, said mesh defining individual slits extending through said layer;
a discontinuous layer on one of said opposed surfaces, and a discontinuous layer on the other of said opposed surfaces.

10. The plant pot, according to claim 9, wherein each of said discontinuous layers comprises a coating having a thickness of at least 5 mil.

11. The plant pot, according to claim 10, wherein each said coating covers between about 5% to about 60% of each surface of said composite layer.

12. The plant pot according to claim 11, wherein each said coating covers between about 10% to about 40% of each surface of said composite layer.

13. The plant pot, according to claim 9, wherein the plastic material forming the strips of said composite is a polyolefin.

14. The plant pot, according to claim 13, wherein said polyolefin is a polyethylene and said coating is a polyethylene compatible with said polyethylene strip.

15. The plant pot, according to claim 9, wherein said slits of said open mesh weave are openings to permit moisture to permeate therethrough.

16. The plant pot, according to claim 11, wherein said slits comprise openings permitting passage of moisture therethrough.
